(19) United States
(12) Patent Application Publication
(10) Pub. No.: US 2026/0298848 A1
(43) Pub. Date: Oct. 1, 2026

(54) Device for Contactless Measurement of the Microstructure of Moving Material Webs

(71) Applicant: IMS Messsysteme GmbH, Heiligenhaus (DE)

(72) Inventors: Horst Krauthäuser, Heiligenhaus (DE); Tobias Terlau, Wülfrath (DE); Lennart Möller, Essen (DE)

(21) Appl. No.: 19/482,257

(22) PCT Filed: May 6, 2024
(86) PCT No.: PCT/EP2024/062396

§ 371 Date: Nov. 7, 2025

(30) Foreign Application Priority Data
May 9, 2023 (DE) 10 2023 112 042.5

(51) Int. Cl. G01N 23/20091; G01N 23/20016; G01N 23/20025

(52) U.S. Cl. CPC G01N 23/20091; G01N 23/20016; G01N 23/20025; G01N 2223/053; G01N 2223/1016; G01N 2223/309; G01N 2223/3308; G01N 2223/642

(57) ABSTRACT

The invention relates to a device for contactless measurement of the microstructure of a moving material web, for example a metal strip, with a specified material web space area for arranging a moving material web, with an X-ray source and a collimator for generating a collimated X-ray beam within an X-ray beam space area. The X-ray beam space area defines a beam axis, with an overlap space area formed by the material web space area and the X-ray beam space area, with an energy-dispersive X-ray detector arranged on the side of the material web space area facing away from the X-ray source and having a measuring angle space area. The measuring angle space area occupies an angle, for example of 2θ, to the X-ray beam space area, which is specified by the spatial direction from the overlap space area to the X-ray detector. This solves the technical problem of further improving the device and enabling a measurement with greater thickness of the material strip, in that the collimator has an annular opening. The X-ray beam space area is essentially cone-shaped and the cone shell defines a cone axis as the beam axis, and that the X-ray detector is arranged in the extension of the beam axis.

### CROSS-REFERENCE TO RELATED APPLICATIONS

This application is the United States national phase of International Patent Application No. PCT/EP2024/062396 filed May 6, 2024, and claims priority to German Patent Application No. 10 2023 112 042.5 filed May 9, 2023, the disclosures of which are hereby incorporated by reference in their entireties.

### BACKGROUND OF THE INVENTION

### Field of the Invention

The invention relates to a device for contactless measurement of the microstructure of moving material webs, for example metal strips.

### Description of Related Art

The mechanical properties of polycrystalline web-shaped products, such as flat-rolled strips made of steel or non-ferrous metals, are influenced by the microstructure. This results in particular from the heat treatment during hot rolling or annealing. The process is controlled, for example, by means of models and the regulation of the material temperature. Due to incorrect temperature measurement, varying dynamic behaviour of the material or deviations in the upstream processes, this approach is often insufficient and leads to defective products.

Direct control of the microstructure eliminates the above-mentioned sources of error and improves yield. This requires measurement of microstructure parameters such as austenite content. An example of this is described in DE 199 41 736 A1. In this case, especially during hot rolling of metal strips, X-rays that penetrate the hot metal strip are recorded online and evaluated. Due to the evaluation crystallographic transformations and/or microstructural transformations and/or chemical transformations that occur at certain temperatures of the metal are recorded. Suitable process control and/or regulation variables for process optimisation are derived from knowledge of the degree of transformation or the transformation course. Based on a process model, this model can be adapted online.

Such a measurement can, for example, be carried out electromagnetically by measuring the electromagnetic properties of the material using a sensor below the strip and correlating them with the microstructure parameters. However, the measurement requires a small distance from the strip, which limits the usable range for measuring the austenite content.

X-ray diffraction is a method regularly used in the laboratory to determine the microstructure. Typically, a backscattering technique is used, in which the X-ray source and the detector are located on the same side of the sample. The method provides good resolution. However, the microstructure is only measured at the surface of the sample and the geometric arrangement of the sample relative to the measuring device must be very stable. The method is therefore not suitable for use in production.

For this reason, a method for angle-dispersive X-ray diffraction in the transmission method was developed, in which the sheet metal is irradiated with X-rays of constant energy and the resulting diffraction patterns are recorded with an X-ray area camera. The system is described in EP 3 465 181 B1 and can be installed in a protective housing in an annealing furnace. The emission energy of the tungsten tube of approx. 60 keV is used for the measurement. The energy is sufficient for measuring steel sheets with a thickness of up to 4 mm. For greater thicknesses, the absorption is too high and the intensity of the residual radiation at the detector is no longer sufficient for angle-dispersive measurement. For example, it must be possible to measure the material strip with a greater thickness in order to determine the austenite content in the cooling section of a hot strip mill.

In order to ensure sufficient signal intensity at the detector during X-ray diffraction in the transmission method, even with higher material thicknesses, the energy of the X-ray radiation must be increased. For angle-dispersive X-ray diffraction, a constant energy is used, which depends on the element of the anode used in the X-ray tube. The tungsten used to date is the element with the highest atomic number and the highest emission energy typically used in X-ray tubes. It is therefore not possible to increase the energy of the radiation here.

In order to ensure sufficient signal intensity at the detector during X-ray diffraction in transmission procedures, even with thicker materials, the energy of the X-rays must be increased. For angle-dispersive X-ray diffraction, a constant energy is used, which depends on the element of the anode used in the X-ray tube. The tungsten used to date is the element with the highest atomic number and the highest emission energy typically used in X-ray tubes. It is therefore not possible to increase the energy of the radiation in this case.

Such higher energy can be generated with a linear accelerator. High intensities can be generated and the radiation is very monochromatic. However, due to the costs involved, such systems are only suitable for experimental measurements.

Furthermore, in angle-dispersive X-ray diffraction, the distances to the strip must be small, as on the one hand the size of the X-ray area camera must increase linearly with the distance. This leads to problems during installation and a poor signal-to-noise ratio (SNR) of the individual camera pixels. On the other hand, as the distance between the X-ray source and the measured material increases, the measuring spot and the width of the diffraction peaks also increase.

WO 2009/043095 A1 discloses an online XRD analyzer with an X-ray source with a collimator with annular opening and an energy-resolved X-ray detector, wherein the positions of the X-ray detector and the X-ray source can be freely varied relative to the measuring range.

WO 2008/149078 A1 describes an XRD analyzer with an X-ray source with a ring collimator and a detection surface containing a detector. The distance of the detector is selected depending on the Bragg-diffracted radiation of the X-ray source at the target object.

WO 2014/111684 A1 describes an XRD analyzer that also has an X-ray source with a ring collimator and a detection surface for detecting X-rays diffracted at a target object. The position of the X-ray detector is selected so that the maximum intensity of the diffracted radiation is found.

Therefore, the technical problem underlying the present invention is to further improve the device for contactless measurement of the microstructure of moving material webs and to enable a measurement at greater thicknesses of the material web.

The problem is solved by using a device for contactless measurement of the microstructure of a moving material web with the features as described herein and by the use of a device for contactless measurement of the microstructure of a moving material web as described herein.

The device according to the invention for contactless measurement of the microstructure of a moving material web is suitable, for example, for measuring a moving metal strip. For this purpose, the device has a specified material web space area for arranging a moving material web. The device has a guide device for guiding a moving material web in the material web space area. For this purpose, the guide device preferably has at least one transport roller. However, the device can also be designed without its own guide device, in which case the material web to be measured passes through the device in a suspended manner and is conveyed and positioned in further devices in the conveying direction in front of and behind the described device.

The material web space area is therefore the spatial area within the device in which the material web moves and is arranged when the device is in use, with the material web being fed in from the outside and fed out again.

The material web space area is defined within specified deviations from a target space area, whereby production-related fluctuations occur and are tolerated. The material web space area is therefore specified with upper and lower limits.

The device according to the invention also has an X-ray source and a collimator for generating a collimated X-ray beam within an X-ray beam space area, wherein the X-ray beam space area defines a beam axis. The X-ray beam space area is also not strictly defined by limits, but exhibits divergence due to the dimensions of the X-ray source itself and the dimensions of the collimator opening.

Furthermore, the beam axis can be aligned essentially at right angles to the material web space area. This alignment results in a symmetrical arrangement of the measuring system within the device relative to the conveyed material web.

The device according to the invention also has an overlap space area formed by the material web space area and the X-ray beam space area. When the device is in use, the overlap space area serves as a measuring area in the material web, also referred to as the measuring spot.

The angle between the X-ray beam space area and the flat material web space area is specified and defines the solid angles in which X-ray intensity occurs due to Bragg diffraction at the crystal structure.

The device also has an energy-dispersive X-ray detector with a measurement angle space area, which is located on the side of the material web space area facing away from the X-ray source. The energy-dispersive X-ray detector is used to record energy spectra of the received X-rays.

Furthermore, according to the invention, the device has the property that the measurement angle space area occupies an angle, for example of 2θ, relative to the X-ray beam space area, which is specified by the spatial direction from the overlap space area to the X-ray detector. The angle 2θ is the same for all energies and all lattice plane distances. Therefore, the detector shows the appropriate energy with a certain intensity and resolution for the different lattice plane distances. This is because for each lattice plane distance there is an energy that is diffracted at the specified angle. The angle only changes if either the material strip or the detector position, i.e. the measurement setup, changes.

Thus, during the measurement, the angle between the X-ray beam, the material web and the X-ray detector is specified and can be set to a value of 2θ. The value of 2θ does not depend on a specific energy of the X-ray radiation or on specific lattice plane distances. The angle for the system results from the collimation and the geometric arrangement of the X-ray source relative to the material web and the detector, and is then specified as a fixed value for a given setup. The angle can be set so that the detected diffracted energies lie within a desired range, for example, an energy range that is higher than the characteristic tungsten radiation and whose energies are large enough to penetrate the thick material of the metal strip. In addition, the energy of the X-rays cannot be greater than the energy that the semiconductor detector can detect with acceptable efficiency. This is because as the energy increases, the probability of a reaction between the radiation and the semiconductor material decreases, so that only a smaller portion of the incoming radiation can be evaluated.

According to the invention, unlike in the angular-dispersive arrangement, a constant diffraction angle is used instead of a constant radiation energy. At least part of the spectrum of the radiation from the X-ray tube is then used for the measurement. The diffracted radiation is detected by an energy-dispersive X-ray detector and the recorded spectra are analysed for intensity maxima. The intensity maxima are each assigned a value of a lattice plane distance. This results, at least in part, in the parameters of the microstructures in the overlap space area within the material web.

According to the following Bragg equation, the diffraction reflections of the lattice planes result in signal peaks in the spectrum of the energy-dispersive X-ray detector.

$${E}_{h k l} = \frac{h \cdot c}{2 \cdot sin ( Θ )} . \frac{1}{{d}_{h k l}}$$

with
dₕₖₗ lattice plane distance
Eₕₖₗ energy
θ diffraction angle
c speed of light
h Planck constant
hkl Miller indices for describing lattice planes in the material

An energy-dispersive detector (EDX sensor), which can be designed as a semiconductor detector, is used to measure the X-ray energy spectrum of the diffracted beam, i.e. the radiation intensity as a function of the radiation energy. When an X-ray photon is absorbed in the sensitive area of such a detector, electron-hole pairs are created there, the number of which is proportional to the energy of the photon. In the spectrum of the X-ray detector, the signal intensity is plotted as a function of the energy of the X-ray quanta.

By determining the energy of an intensity peak, the corresponding lattice plane distance of the irradiated material can be determined.

Depending on the anode material, the X-ray source used exhibits a characteristic intensity peak in the energy spectrum. Since this intensity peak overlaps the diffraction reflections, only the continuous energy spectrum above the energy of the characteristic intensity peak is preferably used for the measurement.

Since the polycrystalline material of the material web or metal strip to be examined has different phases or crystal structures, and the crystal structures in turn have different lattice planes, a large number of diffraction reflections result in the X-ray energy spectrum.

In the case of body-centred cubic (BCC) lattice (ferrite) and face-centred cubic (FCC) lattice (austenite), some of these diffraction reflections overlap.

This overlap can make it difficult to evaluate the intensities of the characteristic energy peaks in the X-ray energy spectrum for the quantitative determination of the phase proportions.

The quantitative determination of the phase proportions can therefore also be carried out using phase analysis, in which the entire function of the X-ray energy spectrum is utilised. Here, the measured X-ray energy spectrum is mathematically reconstructed using characteristic functions. The characteristic functions are determined by measuring the X-ray energy spectrum on known samples with different structural proportions or polycrystalline samples, or by simulation. The phase proportions are calculated from the respective proportions of the characteristic functions using correlation coefficients.

In principle, in a device as described, the collimator may have a single opening, preferably a substantially circular opening. This structure will be used below to explain the property underlying the invention. Due to the single collimator opening, the X-ray beam space area is essentially linear and defines the beam axis. The term “essentially linear” means that there is a widening of the linear propagation of the X-rays due to unavoidable divergence caused by the expansion of the X-ray source and the expansion of the collimator opening. Furthermore, the X-ray detector is arranged at the specified angle to the beam axis, preferably at a right angle.

If the specified angle of the measurement angle space area to the beam axis corresponds to the angle 2θ for a lattice plane distance present in the material of the material web at a specific energy of the X-ray radiation according to the Bragg equation, a signal or peak occurs in the spectrum of the energy-dispersive X-ray detector. The angle 2θ is therefore determined by the geometry, i.e. the angle between the incident X-ray beam within the essentially linear X-ray beam space area and the connection from the X-ray detector to the overlap area or the intersection of the incident X-ray beam with the material web. To satisfy the Bragg condition, the X-ray beam must have the energy corresponding to the lattice plane distance. The diffracted beam then strikes the X-ray detector, which is preferably designed to be almost point-like.

According to the device of the invention, the collimator has an annular opening, in particular a circular annular opening, whereby the X-ray beam space area is essentially cone-shaped and the cone shell defines a cone axis as the beam axis. In addition, the X-ray detector is arranged in the extension of the beam axis. The term “essentially cone-shaped” means that there is a widening of the cone-shaped spread of the X-rays due to unavoidable divergence. The divergence is caused by the spatial expansion of the X-ray source itself and the annular opening of the collimator.

Thus, in order to increase the intensity of the X-rays detected in the X-ray detector, a cone-shaped X-ray beam space area is used instead of an essentially linear X-ray beam space area. The collimator also produces a annular measuring spot in the overlap area in the material web. The X-rays diffracted onto the X-ray detector positioned on the beam axis all have the same diffraction angle 2θ, especially in the case of a precisely rotationally symmetrical setup, and consequently also the same X-ray energy spectrum.

Due to tolerances and changes, e.g. thermal expansion in the geometric structure of the measuring setup, it may not be possible to maintain the rotationally symmetrical alignment with sufficient accuracy in the long term. Since in this case the diffraction angles for all beams are no longer the same, the X-ray energy spectra in the measured spectra shift relative to each other. The diffraction reflections are then broadened in the resulting X-ray energy spectra measured by the detector.

Therefore, in a further embodiment of the device, a movement device, preferably two-dimensional, is provided for a movement of the X-ray detector in a plane essentially perpendicular to the beam axis. Thus, the X-ray detector, preferably almost point-shaped, can be adjusted and tracked via the movement device, if necessary regularly and automatically. In this case, the X-ray detector is moved in the longitudinal and transverse directions by means of an algorithm of a control unit until the width of the maxima or peaks of the diffraction reflections in the spectrum of the energy-dispersive X-ray detector is minimal. Adjustment by means of the movement device can be carried out both during breaks in the use of the device, for example during rolling breaks in the plant in which the device is used, on a sample, and in small steps during ongoing measurement on the moving material web.

In a further embodiment of the described device, the X-ray detector has a one-dimensional or two-dimensional sensor matrix. This means that the optimum position of the X-ray detector can also be determined using a one-dimensional or two-dimensional energy-dispersive X-ray detector. The optimal position can be determined by parallel evaluation of the separate pixels of the sensor matrix. The pixel that produces the narrowest and highest energy peaks in the spectrum is in the optimal position. If the detector is sufficiently large, it is not necessary to adjust the detector position using the movement device.

In a further embodiment of the device, it is provided that the X-ray detector has at least two sensors spaced apart along the beam axis. This means that several X-ray detectors, preferably almost point-shaped or designed as a sensor matrix, can also be arranged one behind the other. This allows the intensity of the X-ray radiation used to be multiplied according to the number of detectors. The distance to the overlap space area and the different solid angles must be taken into account in each case. With this arrangement of at least two X-ray detectors, the signal noise can be further reduced and/or the measurement speed increased.

Furthermore, due to production and transport conditions, the position of the material web within the material web space area may change during use of the device, particularly in the direction of the beam axis. This changes the angle 2θ, for example, the angle 2θ increases when the material web shifts in the direction of the X-ray detector. This in turn leads to a shift in the position of the energy peaks in the spectrum of the energy-dispersive X-ray detector.

This problem can be countered in the device described by making the distance between the X-ray source and the material web space area smaller than the distance between the material web space area and the X-ray detector. This achieves an asymmetrical arrangement of the material web in the device and reduces the influence of the change in position of the material web on the detected diffraction angle and thus on the energy spectra generated. This is because X-rays are always scattered at all angles. However, the detector, which is preferably point-shaped, only covers one area of the diffracted radiation. This area shifts when the material web moves towards the detector.

According to the invention, in order to minimise the influence of the movement of the material web within the material web space, the X-ray detector is arranged at least twice the distance from the X-ray source to the material web space area. This arrangement has the additional advantage that it also accommodates the usual installation conditions, in which the installation space below the material web space area, also known as the roller table, is limited and the greatest possible distance should be maintained above the hot material of a hot strip in the material web space area.

Another advantage of the energy-dispersive measurement is that the geometry of the device can be adapted almost arbitrarily to the geometric specifications of the roller table. The diffraction angle can be adjusted via the design of the annular collimator, allowing different arrangements of the X-ray source and X-ray detector to be realised.

The remaining shift in the energy peaks in the spectrum of the X-ray detector caused by the change in position of the material web, as well as a shift caused by the lattice expansion of the crystal structure, can be compensated for by correction factors during phase analysis. The correction factors can be determined from the diffraction pattern or by an external measurement, e.g. with a distance or temperature measuring device.

### BRIEF DESCRIPTION OF THE DRAWINGS

The invention is explained below with reference to the drawing using examples of implementation. The drawing shows in

FIG. 1 an embodiment of a device for contactless measurement of the microstructure of a moving material web with a substantially linear X-ray beam space area,

FIG. 2 an embodiment of a device for contactless measurement of the microstructure of a moving material web with a substantially cone-shaped X-ray beam space area,

FIG. 3 an embodiment of a device for contactless measurement of the microstructure of a moving material web with a movement device for the X-ray detector,

FIG. 4 an embodiment of a device for contactless measurement of the microstructure of a moving material web with a one-dimensional sensor matrix of an X-ray detector,

FIG. 5 an embodiment of a device for contactless measurement of the microstructure of a moving material web with two X-ray detectors arranged along the beam axis,

FIGS. 6a and 6b an embodiment of a device for contactless measurement of the microstructure of a moving material web with two different vertical positions of the material web space area,

FIG. 7 an embodiment of a device for contactless measurement of the microstructure of a moving material web with an arrangement in a C-measuring bracket, and

FIG. 8 an embodiment of a device for contactless measurement of the microstructure of a moving material web as part of a heat treatment facility.

### DESCRIPTION OF THE INVENTION

In the following description of the various embodiments according to the invention, components and elements with the same function and the same mode of operation are assigned the same reference numerals, even if the components and elements may differ in their dimensions or shape in the various embodiments.

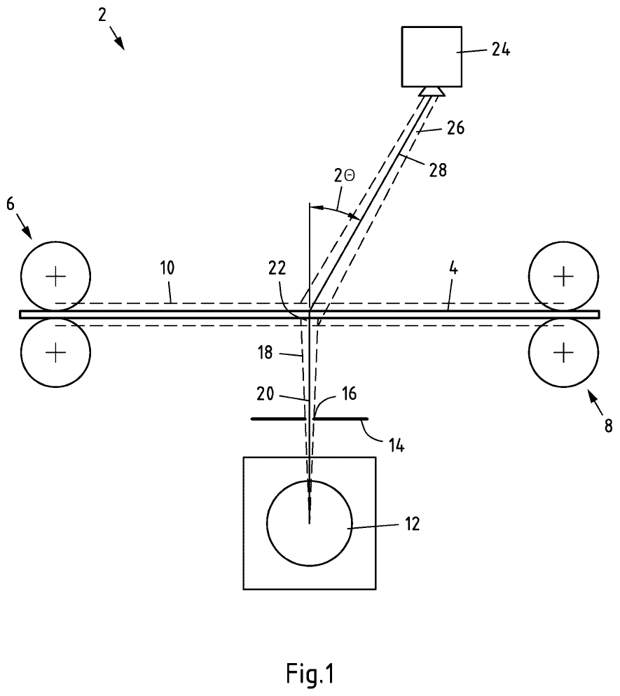

FIG. 1 shows an embodiment of a device 2 for contactless measurement of the microstructure of a moving material web in the form of a metal strip 4 to explain the measuring principle.

A guide device with two pairs of rollers 6 and 8 serves for guiding the moving metal strip 4 within a specified material web space area 10. The material web space area 10 is to be understood as the space area provided in the device 2 in which the metal strip 4 is to be transported. Due to spatial fluctuations of the metal strip 4, the space area is not precisely specified, but has a fluctuation width. The material web space area 10 is shown in FIG. 1 with dashed lines.

The device 2 has an X-ray source 12 and a collimator 14 with a round collimator opening 16 for generating a collimated X-ray beam within an X-ray beam space area 18, wherein the X-ray beam space area 18 specifies a beam axis 20. The dashed lines indicate that the X-ray beam space area 18 has an angular extent that is defined by the flat X-ray source 12 and the equally flat collimator opening 16 of the collimator 14.

The X-ray beam space area 18 is thus essentially linear in shape and defines the beam axis 20. “Essentially linear” means that there is a deviation from a linear propagation of the X-rays due to unavoidable divergence.

In the embodiment shown, the beam axis 20 is essentially at right angles to the material web space area 10. However, the beam axis can also be set at a different angle; the right angle is preferred but is only exemplary.

The material web space area 10 and the X-ray beam space area 18 form an overlap space area 22 in which, during operation of the device 2, the interaction between the X-rays and the microstructure of the metal takes place within the material of the metal strip 4. The overlap space area 22 is therefore the measuring area in the metal strip 4 during operation.

Furthermore, FIG. 1 shows an energy-dispersive X-ray detector 24 arranged on the side of the material web space area 10 facing away from the X-ray source 12. Various types of semiconductor detectors are used as energy-dispersive X-ray detector 24. Cadmium telluride (CdTe) semiconductor detectors and cadmium zinc telluride (CZT) detectors are preferred for use at room temperature. High-purity germanium (HPGe) detectors can also be used, but these require cooling with liquid nitrogen.

Furthermore, the X-ray detector 24 is arranged at the specified angle 2θ to the beam axis 20. The X-ray detector 24 defines a measurement angle space area 26 through the aperture, which is determined by the spatial direction or measuring direction 28 and the angular extension shown as a dashed line. The measurement angle space area 26 is determined from the boundaries of the overlap space area 22 to the opening of the X-ray detector 24. This is because the angular extent of the measurement angle space area 26 is specified by the extent of the overlap space area 22, by the angular dispersion of the X-ray beam space area 18 and by the aperture of the X-ray detector 24.

The measurement angle space area 26 therefore occupies an angle of 2θ to the X-ray beam space area 18, which is specified by the spatial direction from the overlap space area 22 to the X-ray detector 24. The angle 2θ considered does not depend on the parameters of the energy of the X-ray radiation and the lattice plane distance. The angle 2θ is determined by the arrangement of the X-ray beam with the beam axis 20 to the X-ray detector 24. Depending on the lattice plane distance of the microstructure in the metal strip 4, different energies or wavelengths of the X-ray radiation from the continuous X-ray energy spectrum are diffracted at precisely this angle.

The angle 2θ is therefore specified, whereby the expected diffraction is calculated under the diffraction angle θ and the angle 2θ is specified for expected diffraction on the material to be examined and the available energies of the X-ray radiation.

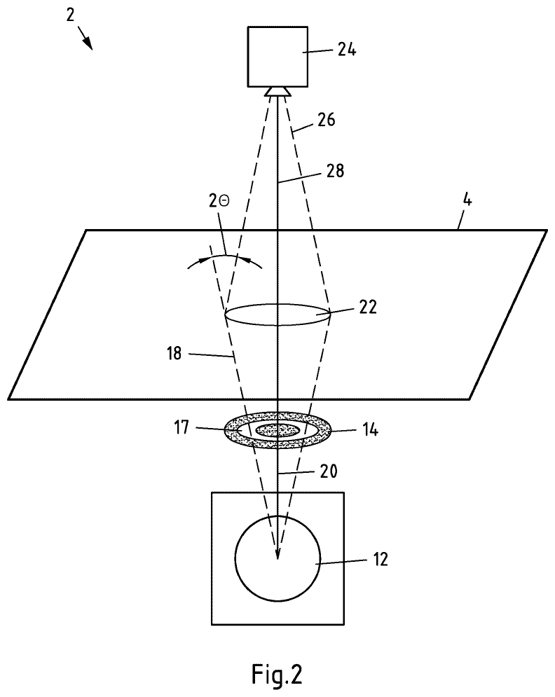

FIG. 2 shows an example of a device 2 according to the invention. In contrast to FIG. 1, no guide device with roller pairs is initially provided; the metal strip 4 is fed in and out at the side of the device. The device 2 therefore operates with a “floating” metal strip 4, which is guided and positioned in the direction of movement before and after the device 2 by further production devices.

Furthermore, according to FIG. 2, the collimator 14 has a circular annular opening 17. The X-ray beam space area 18 is therefore essentially cone-shaped, and the cone shell defines a cone axis as the beam axis 20. The term “essentially cone-shaped” means here that there is a deviation from a cone-shaped propagation of the X-rays due to unavoidable divergence. For reasons of clarity, the X-ray beam space area 18 is not shown with dashed boundary lines in FIG. 2 and all further figures.

The overlap space area 22 and thus the space area irradiated in the metal strip 4 is annular. Furthermore, the X-ray detector 24 is arranged in the extension of the beam axis 20. This results in a symmetrical setup in the ideal case. This is because, under the solid angle of 2θ, the diffracted X-rays are also directed onto the X-ray detector 24 in a cone-shaped manner, starting from the annular overlap space area 22. This increases the measured intensity of the diffracted X-rays compared to the arrangement shown in FIG. 1.

The X-ray detector 24 defines a measuring angle space area 26 that is also cone-shaped (here without limiting lines as shown in FIG. 1) through the aperture, which is determined by the measuring direction 28, which essentially coincides with the beam axis, and the angular extension of the collimator opening 17. The angular extension of the measuring angle space area 26 is also determined by the angular dispersion of the X-ray beam space area 18, by the extension of the annular overlap space area 22 and by the aperture of the X-ray detector 24.

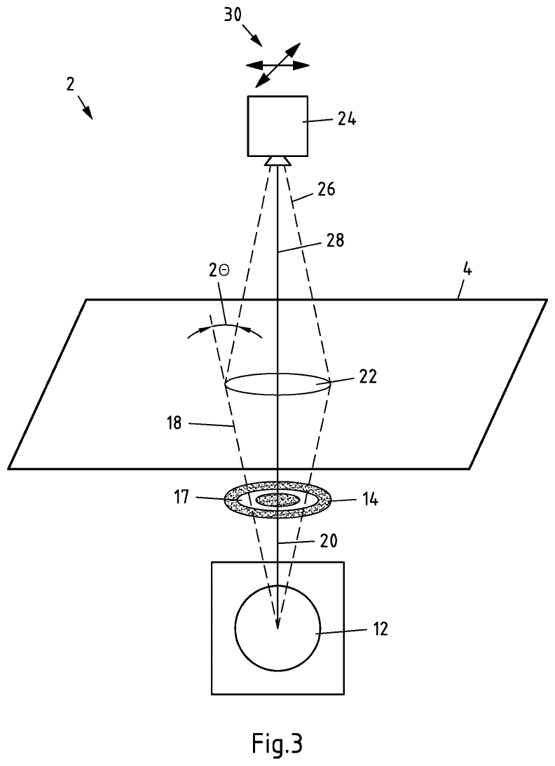

FIG. 3 shows a further embodiment with an extended design compared to FIG. 2, with a two-dimensional movement device 30 for a movement of the X-ray detector 24 in a plane essentially perpendicular to the beam axis 20. The movement device 30 is schematically represented by two intersecting arrows.

With the aid of the movement device 30, the position of the X-ray detector 24 can be changed in order to obtain the best possible signal in the spectrum of the energy-dispersive X-ray detector 24.

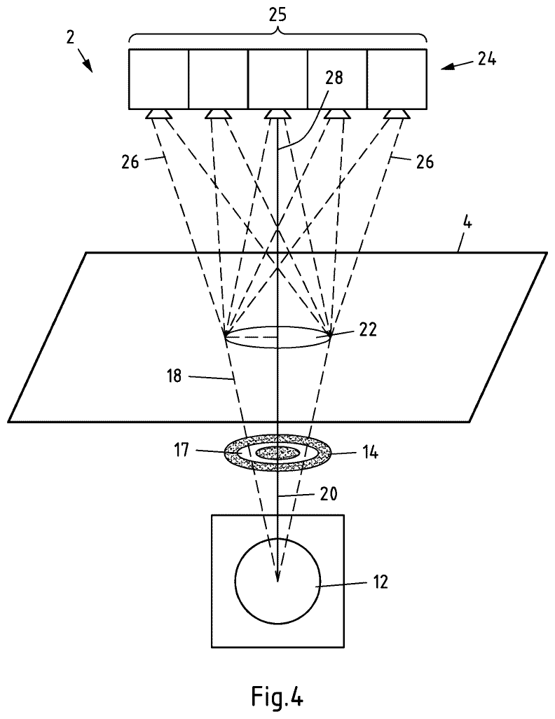

As an alternative or in addition to the design shown in FIG. 3, FIG. 4 shows an example of an embodiment in which the X-ray detector 24 has a two-dimensional sensor matrix 25. Using the separate energy-dispersive sensors of the sensor matrix 25, several spectra are recorded and evaluated in parallel. Thus, when the sensor matrix 25 is arranged in a stationary manner, the sensor that generates the best signal can be determined. The spectra subsequently measured and determined by this sensor are then selected for measuring the microstructure. The camera-like shown sensors of the sensor matrix 25 are shown schematically and may also be designed to be significantly smaller in relation to the device shown. In particular, the sensor matrix may also be designed as a sensor chip with a plurality of individual X-ray detectors on a chip.

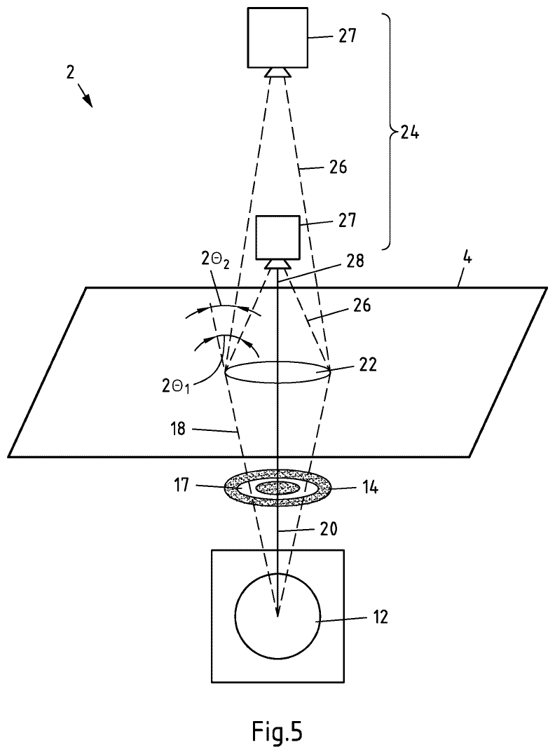

FIG. 5 shows a further preferred embodiment of the device 2. In contrast to the embodiments described so far, the X-ray detector 24 has at least two sensors 27 spaced apart along the beam axis 20. Slightly different angles 2θ₁ and 2θ₂ apply to both sensors 26, which lead to spectra that are shifted relative to each other. However, this shift is calculable and can be compensated for. Overall, this arrangement of the sensors 27 again results in improved quality of the measurement results.

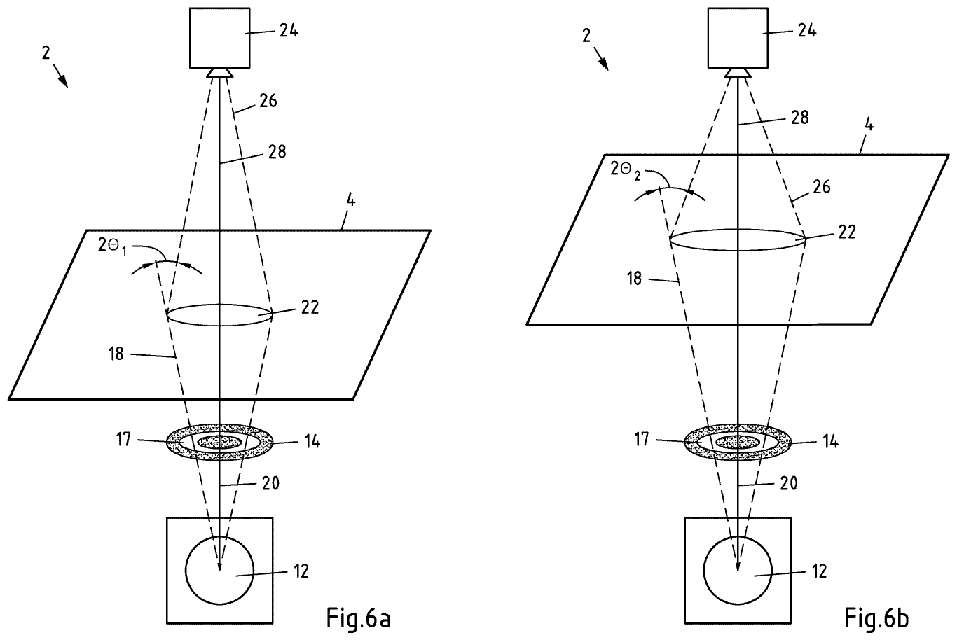

FIGS. 6a and 6b show the effect that a vertical shift in the position of the metal strip 4 in the device 2 has on the measurement results. A different angle of 2θ₁ and 2θ₂ applies to each of the two vertical positions shown. Since the vertical fluctuations of the metal strip 4 within the device 2 occur unpredictably, correction functions used in signal processing must be applied to calculate the resulting deviations.

One measure to reduce the effect is to make the distance between the X-ray source 12 and the material web space area 10 smaller than the distance between the material web space area 10 and the X-ray detector 24. A distance that is at least twice as large is preferred. The greater the distance between the material web space area 10 and the X-ray detector 24, the less effect vertical fluctuations of the metal strip 4 have.

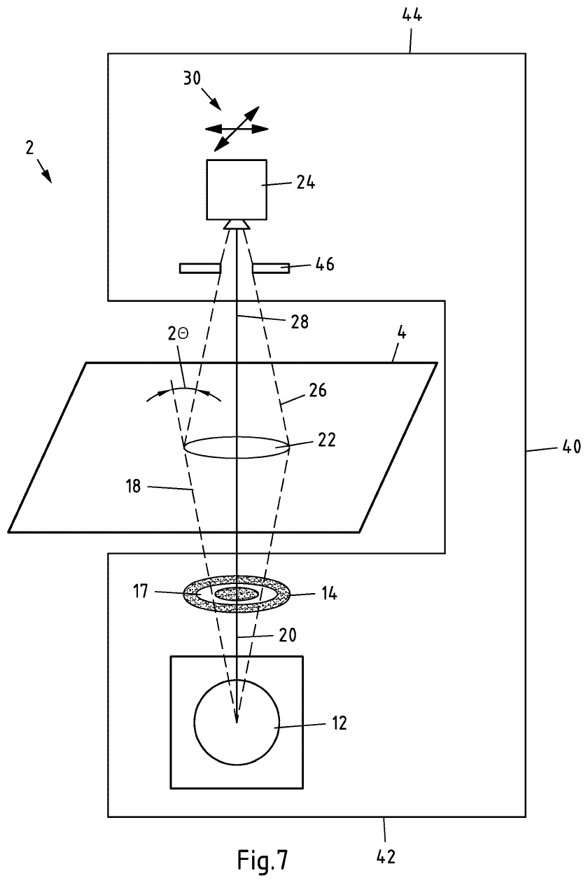

FIG. 7 shows an application of the device 2 for installation in a hot strip mill by means of a C-measuring bracket 40.

The X-ray source 12 and the collimator 14 with the annular collimator opening 17 are located in the lower arm 42 of the C-measuring bracket 40. Above the X-ray source 12, an X-ray beam is formed in the cone-shaped X-ray beam space area 18. The X-ray beam strikes the metal strip 4, forms an annular measuring site in the overlap space area 22 and is diffracted at the diffraction angle 2θ to the X-ray detector 22.

To minimise the influence of the vertical movement of the metal strip 4, the X-ray detector 24 is arranged in the upper arm 44 at a distance at least twice the distance from the X-ray source 12 to the metal strip 4. This also accommodates the usual installation conditions, in which the installation space below the material web space area 10, also referred to as the roller table, is limited and the greatest possible distance from the X-ray detector 24 should be maintained above the hot metal strip 4.

In front of the X-ray detector 24, the beam is limited by a further collimator 46 so that the width of the diffraction reflections is reduced. The X-ray detector 24 is equipped with a movement device 30 for automatic adjustment of the detector position. In addition, the influence of disturbing scattered radiation, which can also occur at other locations within the device, is reduced.

The measuring bracket 40 can be moved into the rolling mill for measurement. In the position next to the rolling mill, regular checks and corrections of the detector position can be carried out. In addition to the detector position, the measurement accuracy and/or reproducibility of the measurements can also be checked with reference samples outside the roller table.

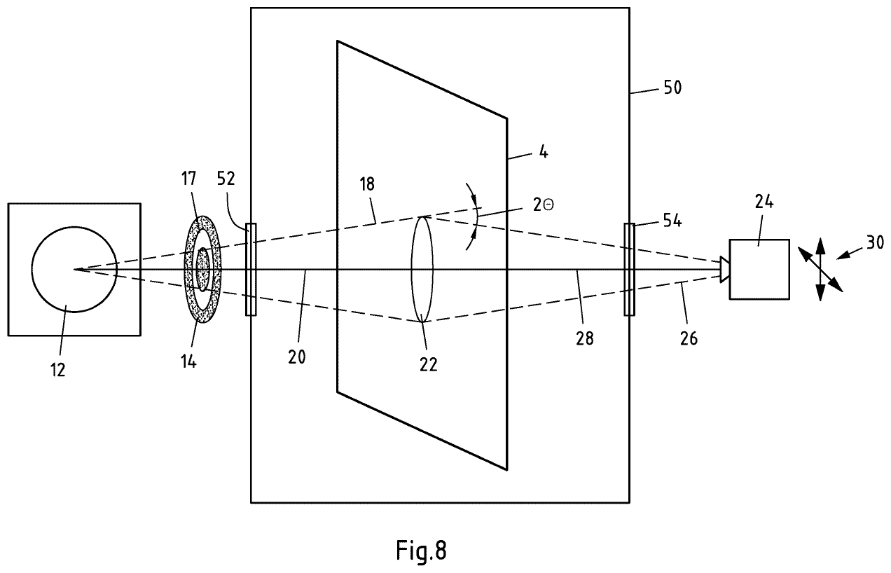

FIG. 8 shows an application of the device 2 in a heat treatment facility 50. Here, the X-ray source 12 and the X-ray detector 24 are arranged outside the heat treatment facility 50. The rays penetrate through windows 52 and 54 with a low absorption coefficient. As described above, the cone geometry of the X-rays allows for large distances, and the required size of windows 52 and 54 is small. The alignment of X-ray detector 24 with X-ray source 12 is again achieved by means of the movement device 30.

1-5. (canceled)

6. A device for contactless measurement of the microstructure of a moving material web, for example a metal strip,
with a specified material web space area for arranging a moving material web,
with a guide device for guiding a moving material web in the material web space area,
with an X-ray source and a collimator for generating a collimated X-ray beam within an X-ray beam space area, wherein the X-ray beam space area defines a beam axis,
with an overlap space area formed by the material web space area and the X-ray beam space area,
with an energy-dispersive X-ray detector arranged on the side of the material web space area facing away from the X-ray source and having a measuring angle space area,
wherein the measurement angle space area occupies an angle, for example of 2θ, relative to the X-ray beam space area, which is specified by the spatial direction from the overlap space area to the X-ray detector,
wherein the collimator has an annular opening,
wherein the X-ray beam space area is essentially cone-shaped and the cone shell defines a cone axis as the beam axis, and
wherein the X-ray detector is arranged in the extension of the beam axis,
wherein
the X-ray detector is arranged at least twice the distance from the X-ray source to the material web space area.

7. The device according to claim 6,
wherein
a movement device, preferably two-dimensional, is provided for a movement of the X-ray detector in a plane essentially perpendicular to the beam axis.

8. The device according to claim 6,
wherein
the X-ray detector has a one-dimensional or two-dimensional sensor matrix.

9. The device according to claim 6,
wherein
the X-ray detector has at least two sensors spaced apart along the beam axis.
